(19) United States
(12) Patent Application Publication
(10) Pub. No.: US 2024/0412182 A1
(43) Pub. Date: Dec. 12, 2024

(54) SERVERS, SYSTEMS, AND METHODS FOR INTERCEPTING AND MODIFYING TRANSACTIONAL COMMUNICATIONS

(71) Applicant: Global Electronic Technology, Inc., Torrance, CA (US)

(72) Inventors: Roberto Antonio Sato, Irvine, CA (US); Luis Alberto Mego Canta, Santa Clarita, CA (US); Scott Howard Bryson, Rancho Palos Verdes, CA (US)

(21) Appl. No.: 18/737,652

(22) Filed: Jun. 7, 2024

Related U.S. Application Data
(60) Provisional application No. 63/642,126, filed on May 3, 2024.
(60) Provisional application No. 63/507,346, filed on Jun. 9, 2023.

(51) Int. Cl. G06Q 20/10; G06Q 20/22

(52) U.S. Cl. CPC G06Q 20/10; G06Q 20/227

(57) ABSTRACT

In some embodiments, the disclosure describes a system that allows for advanced payment instructions to be included in electronic transmissions without the need to hard-code the payment instructions into an online platform. In some embodiments, the system is configured to intercept electronic transaction transmissions from an acquirer processors. In some embodiments, the system is configured to receive payment instructions from an acquirer processor and replace and/or augment the payment instructions. In some embodiments, the system is configured to consolidate information from multiple sources and display analysis of the information. In some embodiments, information displayed by the system includes artificial intelligence driven analytics. In some embodiments, the AI is configured to determine the most relevant information to display to a user. In some embodiments, analytics provided by the system include sales, authorizations, settlements, deposits, and disputes.

### CROSS-REFERENCE TO RELATED APPLICATIONS

This application claims priority and the benefit of U.S. Provisional Application No. 63/642,126 filed May 3, 2024, and claims priority and the benefit of Provisional Application No. 63/507,346 filed Jun. 9, 2023, the entire contents of which are incorporated herein by reference.

### BACKGROUND

According to industry leaders, 75% of the 2022 Forbes Cloud 100 and numerous leading internet companies, including Amazon.com, Inc.® and Zoom Video Communications, Inc.®, have changed from legacy payment platforms to modern payment infrastructures (e.g., Stripe, Inc.® and its competitors). In a recent study conducted by Forrester Research, Inc.®, a private SaaS company achieved substantial cost savings of $1.6 million by transitioning from credit-card monthly subscription charges to collecting subscription funds through each merchant account. This successful cost reduction was made possible by switching from a legacy payment platform to a payfac-as-a-service platform.

However, conventional payment platforms are failing to meet the expectations of modern businesses. Outdated onboarding and underwriting processes create friction points for merchants, leading to delays in revenue generation. Their limited monetization capabilities and lack of flexible funding options cause missed revenue opportunities and inefficient operations.

Therefore, there is a need in the art for a payment system that can easily integrate into existing merchant platforms (e.g., Authorize.Net®, Network Merchants, LLC®) while providing an improved transaction experience over the prior art.

### SUMMARY

In some embodiments, the system is configured to integrate advanced payment capabilities into an existing transactional platform, eliminating the need to switch from a current payment platform. In some embodiments, a transactional platform includes one or more of companies (merchant platforms), payment platform code integrations, payment gateways, acquirer processors, funding instructions, and/or acquiring banks (see FIG. 1). In some embodiments, the system is configured to be implemented for one or more individual merchants and/or an entire merchant base. In some embodiments, the system is configured to enable a customer (e.g., merchant and/or merchant platform) to choose one or more payment capabilities that align with one or more business requirements. In some embodiments, the system includes no-code and/or API integrations that do not require existing code to be modified in order to integrate existing transactional platforms into the system described herein. In some embodiments, low-code integrations can be used as desired. In some embodiments, low-code includes embedding only a portion of system code into a merchant platform. In some embodiments, the portion is configured to enable a link to customizable features provided by the system from an outside system platform, such that the low-code does not have to be modified to modify customer transactions.

In some embodiments, the system is configured to intercept and/or receive one or more transactions and add one or more of real-time onboarding, funding flow management, dynamic pricing, advanced residuals (as some non-limiting examples described herein) to improve the capabilities of prior art payment platforms. In some embodiments, the system is configured to automatically integrate between an acquirer processor and an acquiring bank in the transactional platform (merchant platform) which enables the system to intercept one or more transactions.

In some embodiments, the system includes a (substantially) real-time onboarding module. In some embodiments, the onboarding module is configured to enable customers to sign up for merchant accounts within minutes through user-friendly graphical user interfaces (GUIs) and/or application programming interfaces (APIs). In some embodiments, the system is configured to enable a customer (e.g., user) to choose whether to deliver the payment platform credentials via email and/or (instantly) activate the customer's account on a customer platform through webhooks.

In some embodiments, the system includes a funding flow management module. In some embodiments, the funding flow management module is configured to provide flexibility for the intercepted transaction by one or more of: enabling split payments based on percentage or dollar amounts; configuring custom fee structures billed on a daily, weekly, or monthly basis; and supporting complex instructional funding at the transaction level.

In some embodiments, the system includes a dynamic pricing module. In some embodiments, the dynamic pricing module is configured to enable a customer to create, by way of intercepting the transaction, different pricing programs tailored to a merchant's needs and/or desires. In some embodiments, these programs are based on subscription plans (e.g., free, pro or premium) and/or volume tiers (discount rates decrease as volume exceeds a threshold). In some embodiments, the system is configured to enable a user to add more complex dynamic pricing structures to the intercepted transaction via APIs.

In some embodiments, the system includes an advanced residual module. In some embodiments, the advanced residual module is configured to enable a customer to select options for receiving residual payments. In some embodiments, the advanced residual module is configured to enable a customer to select daily, weekly, and/or monthly residual payments, which is not a feature available in the prior art, and which is enabled by integrating the system into a payment framework as described herein. In some embodiments, upgrading a deposit method allows for faster residual delivery through deposits to debit cards, which is a performance improvement over the prior art.

By leveraging the integrated modules of the system into a conventional transactional platform, along with other system products such as advanced authorization optimization, fraud prevention, and dispute management, businesses can effortlessly enhance their systems and embrace the benefits of modern payment capabilities provided by the system according to some embodiments.

In some embodiments, the system represents a groundbreaking advancement in payment infrastructure for legacy acquiring processors, acquiring banks, independent service providers (ISVs), and agents. In some embodiments, through the integration of innovative technologies to intercepted transactions, the system democratizes modern payment infrastructures, making them instantly accessible to all.

In some embodiments, the system is configured to integrate one or more prior art services into a merchant/business transaction platform without coding and/or using only a portion of a payment platform's code.

In some embodiments, the system is configured to enable a customer to hold payments by default and/or release payments via settings transmitting through one or more APIs.

In some embodiments, the disclosure is directed to a system for processing electronic payments comprising one or more computers comprising one or more central processing units (CPUs) and one or more non-transitory computer readable media. In some embodiments, the one or more non-transitory computer readable media comprises program instructions stored thereon that when executed cause the one or more computers to implement one or more algorithm steps. Some embodiments include a step to execute, by the one or more CPUs, a transaction modifier engine configured to modify transactional data. Some embodiments include a step to receive, by the one or more CPUs, first transactional data from one or more acquirer processors. Some embodiments include a step to compare, by the one or more CPUs, the first transactional data to transactional information stored by the transaction modifier engine. Some embodiments include a step to modify, by the one or more CPUs, the first transactional data into second transactional data using the transactional information. Some embodiments include a step to send, by the one or more CPUs, the second transactional data to one or more acquiring banks.

In some embodiments, the one or more non-transitory computer readable media further comprises program instructions stored thereon that when executed cause the one or more computers to integrate, by the one or more CPUs, the transaction modifier engine with a transactional platform. In some embodiments, the transactional platform comprises a link to one or more payment gateways. In some embodiments, the one or more payment gateways are configured to receive the transactional data from a merchant. In some embodiments, the one or more payment gateways are configured to send the transactional data to the one or more acquirer processors as the first transactional data. In some embodiments, the one or more acquirer processors are configured to send the first transactional data to the one or more acquiring banks.

In some embodiments, the integration includes the transaction modifier engine intercepting the first transactional data sent from the one or more acquirer processors to the one or more acquiring banks. In some embodiments, the transactional platform comprises hard coding configured to instruct the one or more acquirer processors to send the first transactional data directly to the one or more acquiring banks. In some embodiments, the integration does not require changing the hard coding of the transactional platform. In some embodiments, executing the transaction modifier engine includes executing instructions configured to prevent and/or delay a transmission of the first transactional data from the one or more acquirer processors to the one or more acquiring banks.

In some embodiments, the one or more non-transitory computer readable media further comprise program instructions stored thereon that when executed cause the one or more computers to prevent, by the one or more CPUs, a transmission of the first transactional data from the one or more acquirer processors to the one or more acquiring banks. In some embodiments, the second transactional data includes funding instructions not included in the first transactional data. In some embodiments, the funding instructions include instructions to divide a payment to the merchant among a plurality of accounts.

In some embodiments, the transaction modifier engine includes a dynamic pricing module configured to enable the merchant to create different pricing programs. In some embodiments, the different pricing programs include subscription programs. In some embodiments, the different pricing programs include how a merchant's transactions will be priced. In some embodiments, the different pricing programs include different deposit methods.

In some embodiments, the one or more non-transitory computer readable media further comprise program instructions stored thereon that when executed cause the one or more computers to store, by the one or more CPUs, a plurality of transactional data associated with the merchant. Some embodiments include a step to execute, by the one or more CPUs, an analysis of the plurality of transaction data. In some embodiments, the one or more non-transitory computer readable media further comprise program instructions stored thereon that when executed cause the one or more computers to generate, by the one or more CPUs, a graphical user interface (GUI) configured to enable a user to access the transaction modifier engine.

In some embodiments, the graphical user interface is configured to enable the user to implement one or more of: subscription plans, deposit methods, settlement instructions, merchant transactional prices, and residuals. In some embodiments, the graphical user interface is configured to display reports based on the plurality of transactional data. In some embodiments, the reports comprise one or more of authorizations, settled batches, settled volume, deposits, disputes, and statements. In some embodiments, the reports are generated using artificial intelligence (AI).

### DRAWING DESCRIPTION

FIG. 1 shows a conventional transaction platform according to some embodiments.

FIG. 2 illustrates the advanced settlement capabilities provided by the system integration according to some embodiments.

FIG. 3 illustrates the systems capability to expand to more acquirer processors and acquiring banks by ingesting new settlement files from new acquirer processors and re-routing advanced funding instructions to new acquiring banks according to some embodiments.

FIG. 4 illustrates aspects of the system that would enable the addition of settlement instructions for newer payment platforms.

FIG. 5 shows various aspects of the advanced transactional platform resulting from system integration according to some embodiments.

FIG. 6 depicts a zoomed view of FIG. 5 section A according to some embodiments.

FIG. 7 shows a zoomed view of FIG. 5 section B according to some embodiments.

FIG. 8 depicts a zoomed view of FIG. 5 section C according to some embodiments.

FIG. 9 shows a non-limiting example system dashboard according to some embodiments.

FIG. 10 depicts an authorizations GUI according to some embodiments.

FIG. 11 illustrates a settled batches GUI according to some embodiments.

FIG. 12 shows a settled volume GUI according to some embodiments.

FIG. 13 shows a deposits GUI according to some embodiments.

FIG. 14 illustrates a disputes GUI according to some embodiments.

FIG. 15 shows a statements GUI.

FIG. 16 illustrates a computer system 1610 enabling or comprising the systems and methods in accordance with some embodiments.

### DETAILED DESCRIPTION

In some embodiments, the disclosure is directed to systems and methods for integrating processing instructions to an intercepted transmission. In some embodiments, the system does not require coding for integration into existing payment systems.

Connecting a company (e.g., merchant platform, merchant website) to a conventional payment platform requires coding in order to interact with a payment gateway. In some embodiments, the system includes payment gateways. The one or more payment gateways are configured to process electronic transactions, which include the use of credit and/or debit cards, as well as Automated Clearing House (ACH) payments according to some non-limiting embodiments. In some embodiments, the one or more payment gateways are configured to encrypt payment details. In some embodiments, the one or more payment gateways are configured to send, by one or more central processing units (CPUs), the encrypted transaction to an acquirer processor.

In some embodiments, the no-code implementation is configured to work with any conventional merchant platforms integrated with any payment gateways (and/or terminals) that are supported by one legacy processor and/or the processor itself. In some embodiments, non-limiting example legacy processors include Total Systems Services LLC.®. In some embodiments, the system includes one or more processors which provide payment processing services, merchant services, and/or related payment services.

In some embodiments, the system comprises one or more computers that include one or more CPUs and one or more non-transitory computer readable media. In some embodiments, the one or more non-transitory computer readable media includes program instructions stored thereon that, when executed, cause the one or more computers to implement a series of steps.

In some embodiments, a step includes to receive, by the one or more CPUs, a transaction request from a customer. In some embodiments, the request is received from a merchant website. In some embodiments, the transaction request includes a purchase order and/or payment details. Some embodiments include a step of sending the transaction request to a payment gateway. Some embodiments include a step comprising sending the transaction request to a payment gateway via hard-coded instructions. As used herein, hard-code and/or hard-coded refers to fixed portions of written program instructions that cannot be altered without altering and/or adding to the structure of the entire program.

Some embodiments include a step comprising sending the transaction to one or more acquirer processors. Some embodiments include a step comprising an acquirer processor sending the transaction to one or more issuing banks. In some embodiments, a step includes the one or more issuing banks verifying the transaction request. Some embodiments include a step comprising sending the verified transaction request from the issuing bank to the acquirer processor. Some embodiments include a step comprising the acquirer processor sending the verified transaction request to the payment gateway. Some embodiments include a step comprising approving the transaction and fulfilling the transaction (e.g., settlement) through the acquiring bank.

Some embodiments include a step comprising receiving, by the one or more CPUs, an integration request, wherein the integration request includes a request to integrate one or more aspects of the system into the transactional platform. Some embodiments include a step comprising executing, by the one or more processors, an integration of one or more aspects of the system into the transactional platform as described herein.

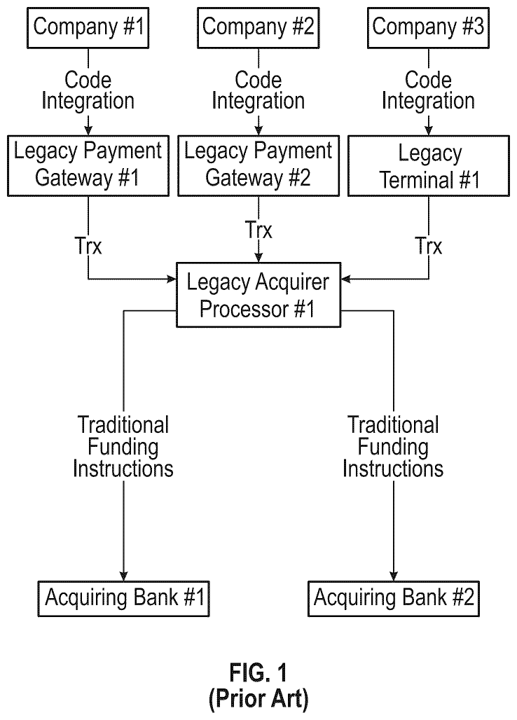

FIG. 1 shows a conventional transaction platform before system integration according to some embodiments. In some embodiments, companies (e.g., ISVs, Online Platforms, Marketplace Platforms, etc.) capture the payment transactions on behalf of their customers (merchants, merchant websites, merchant platforms, etc.) and send them through their integrations to conventional payment gateways, which then sends them to conventional acquirer processors for authorization by the card networks. In some embodiments, at the end of each day, for example, the conventional acquirer processors send the funding instructions to the acquiring banks to deposit all the money that was collected that day into each customer's bank account according to the instructions.

One problem with prior art systems is that these instructions are hard-coded into a company's digital framework and cannot be easily altered. In some embodiments, to alter the prior art transaction platform in FIG. 1, the platform would need to alter the code according to each merchant's request, which is not feasible due to cost and time constraints.

In some embodiments, the system provides a “no-code” integration with an existing transaction platform. In some embodiments, the system is configured to interface with any company linked to any payment gateway (and/or terminal) supported by one legacy processor (e.g., Total System Services LLC® as one non-limiting example) and/or the processor itself. Non-limiting examples of gateways the system is integratable with include Authorize. Net®, Network Merchants, LLC®, Fiserv Inc.®, WorldPay, Inc.®, and others. In some embodiments, to be able to get the advanced settlement capabilities, the system is configured to enable the company to ask its existing and/or future merchants to get a merchant account. In some embodiments, the system includes onboarding APIs, as well as onboarding hosted pages as a no-code option for system integration.

In some embodiments, the system is configured to issue the merchant account credentials that are required for the payment gateway that is being used by the company and/or merchant, then provides them to the merchant and/or company as required by the business model.

In some embodiments, the company (e.g., merchant website, merchant platform), with no or no extra coding efforts, is now able to start using the advanced settlement capabilities by accessing the system dashboard displayed on one or more graphical user interfaces (GUIs) and configuring the settlement instructions (e.g., split payments, daily residuals, custom fees, etc.) that will be applied to each of their merchants' transactions. In some embodiments, these settlement instructions are recorded in the system data store layer.

In some embodiments, at the end of each processing day, for example, all the transactions from the company's merchants are settled into a bank account managed by the acquiring bank. In some embodiments, the funds are deposited into this account via next-day or same-day funding. In some embodiments, currently legacy processors deposit the money directly into the merchant's account with no option to add settlement instructions to the deposit information. In some embodiments, the system is configured to enable companies and/or merchants to add funding instructions to deposit information.

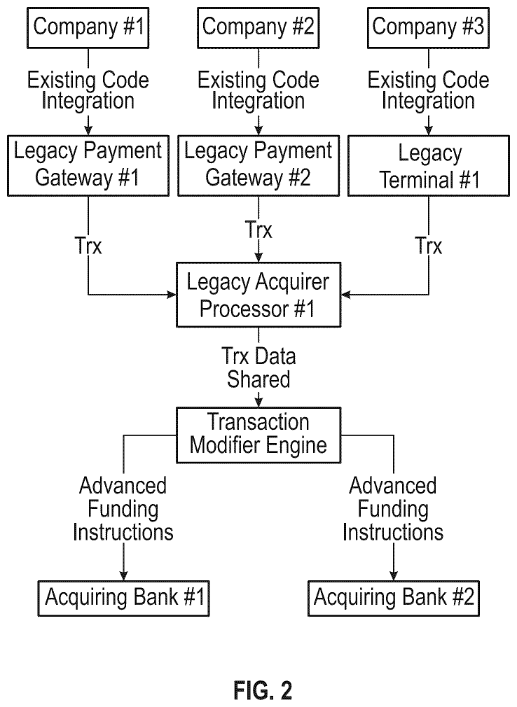

FIG. 2 illustrates the advanced settlement capabilities provided by the system integration according to some embodiments. In some embodiments, the system includes an advanced billing engine configured to pull each company's settlement instructions from the data stores, match the transaction, merchant, and settlement instructions, and/or generate the settlement instructions that are sent to the acquiring bank. In some embodiments, these settlement instructions comprise automated clearing house (ACH) files as a non-limiting example of multiple payout options.

In some embodiments, the system is configured to generate reconciliation and/or reporting of the transactions to be able to visualize the settlement, splits, fees, etc., that were applied to the transaction and/or merchant as specified by the settlement instructions.

In some embodiments, the system includes a payment platform configured to ingest and/or process transaction files from legacy acquiring processors (e.g., Total System Services LLC®), track settlement instructions, and/or changes to settlement instructions in-transit between issuing banks and merchant bank accounts.

As shown in FIG. 2, after system integration, the new system transactional platform is now configured to enable companies to use an existing transactional platform's gateways, acquirer processors, and/or acquiring banks without adding any additional code (i.e., no-code integration) and add advanced settlement capabilities. In some embodiments, the system is configured to intercept communications between the (legacy) acquirer processor and the acquiring bank to enhance their settlement capabilities in-transit by leveraging communication between both.

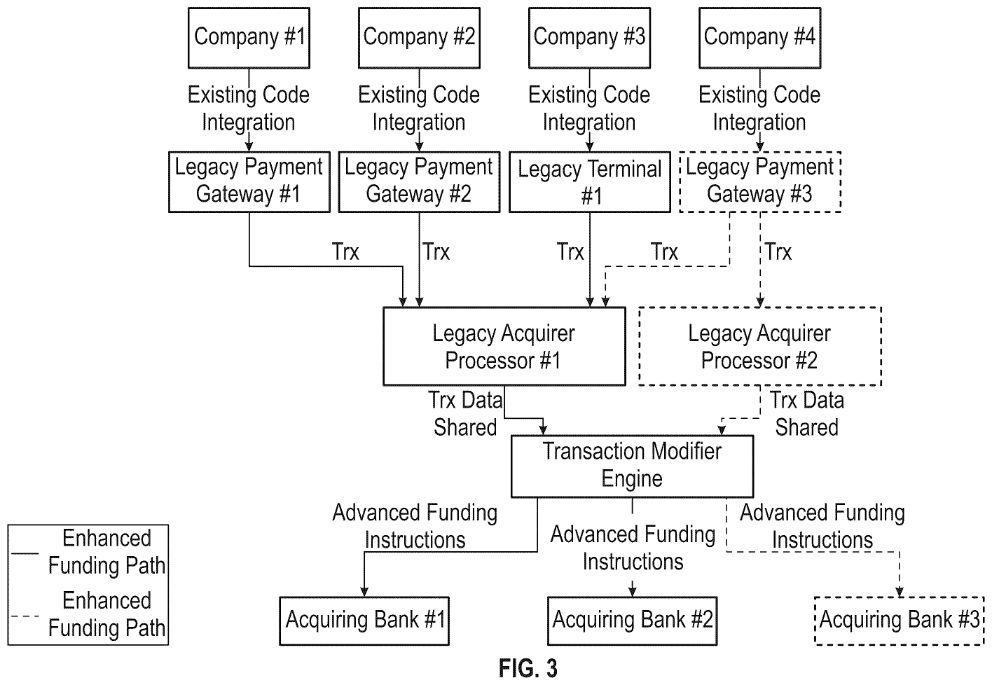

In some embodiments, the system is configured to interface with multiple acquirer processors. In some embodiments, the system is configured to simultaneously interface with multiple acquirer processors. In some embodiments, the system is configured to simultaneously interface with multiple acquiring banks. In some embodiments, the system is configured to interface with multiple acquiring banks. FIG. 3 illustrates the system's capability to expand to more acquirer processors and acquiring banks by ingesting new transactional data settlement files from new acquirer processors and re-routing advanced funding instructions to new acquiring banks according to some embodiments.

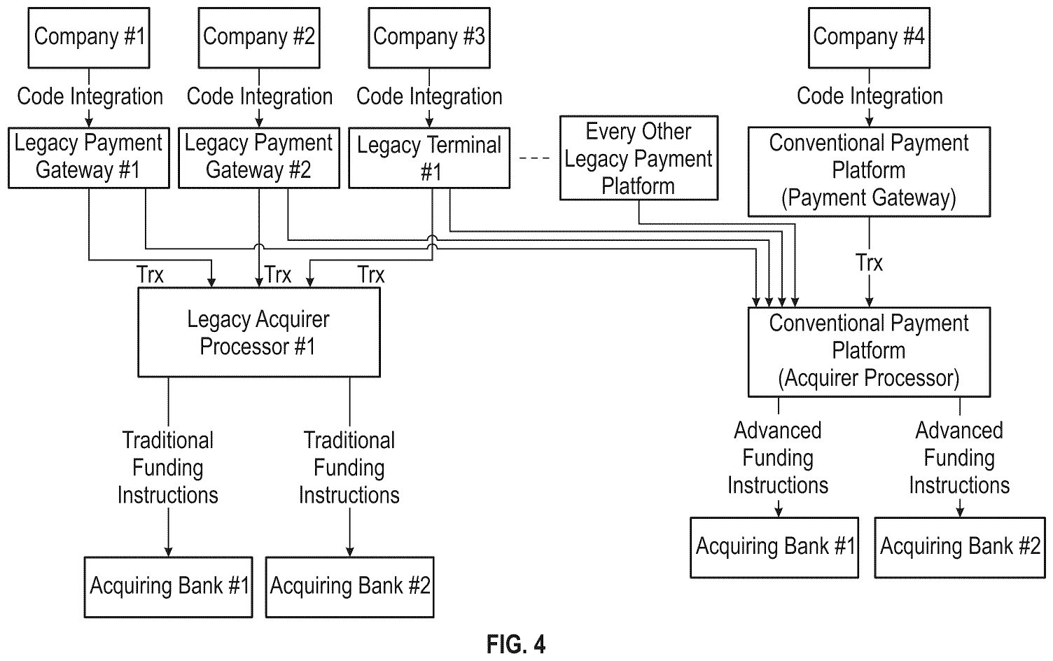

As mentioned previously, prior art payment platforms do not have the capability to add settlement instructions to a gateway. FIG. 4 illustrates aspects of the system that enable the addition of settlement instructions for these payment platforms. In some embodiments, the system includes a direct integration of one or more gateways with the payment platform. In some embodiments, this includes a payment platform partnering with a sponsor bank and establishing a relationship with each acquirer processor to be able to receive the same functional data. However, this solution requires an update to the entire payment platform's onboarding, settlement, risk, billing, and funding engines to support the new acquirers' settlement data. Therefore, the novel integrations shown in FIGS. 2 and 3 save time and/or are scalable without the use of coding which reduces computer resource requirements according to some embodiments.

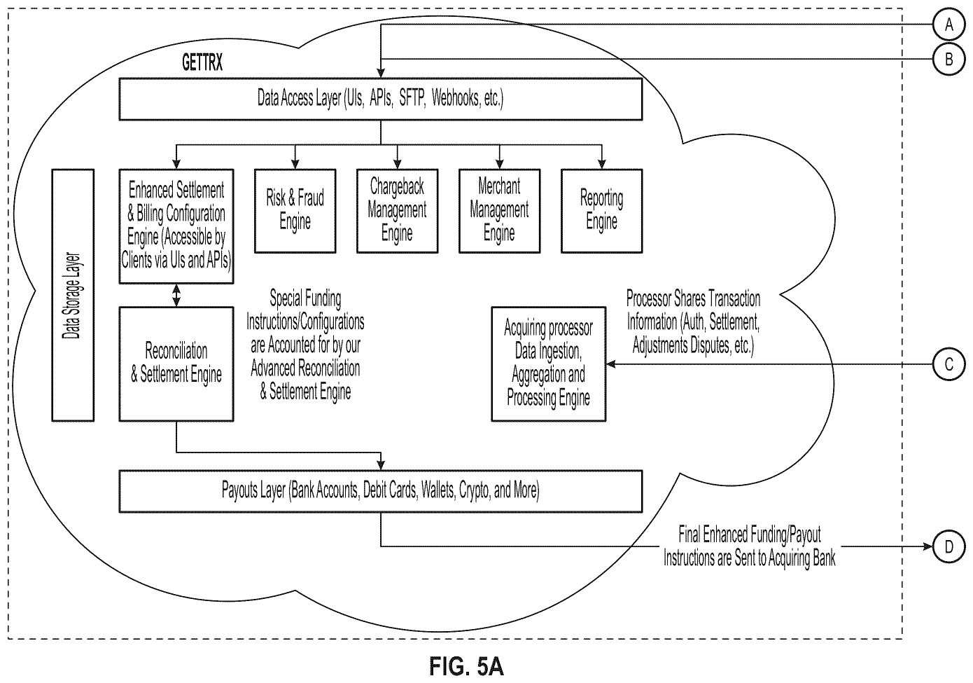

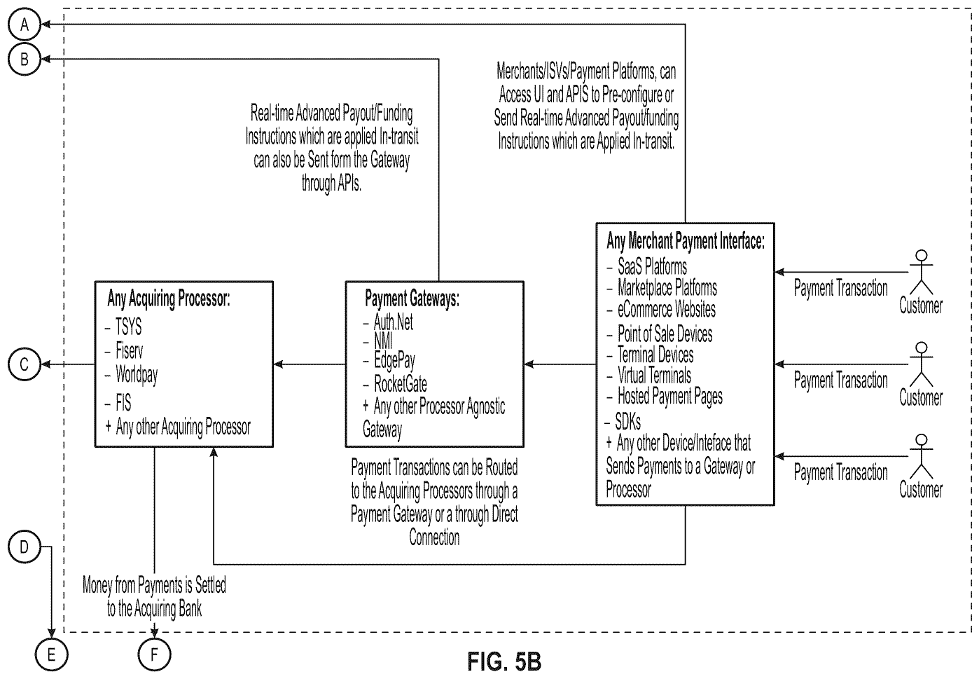

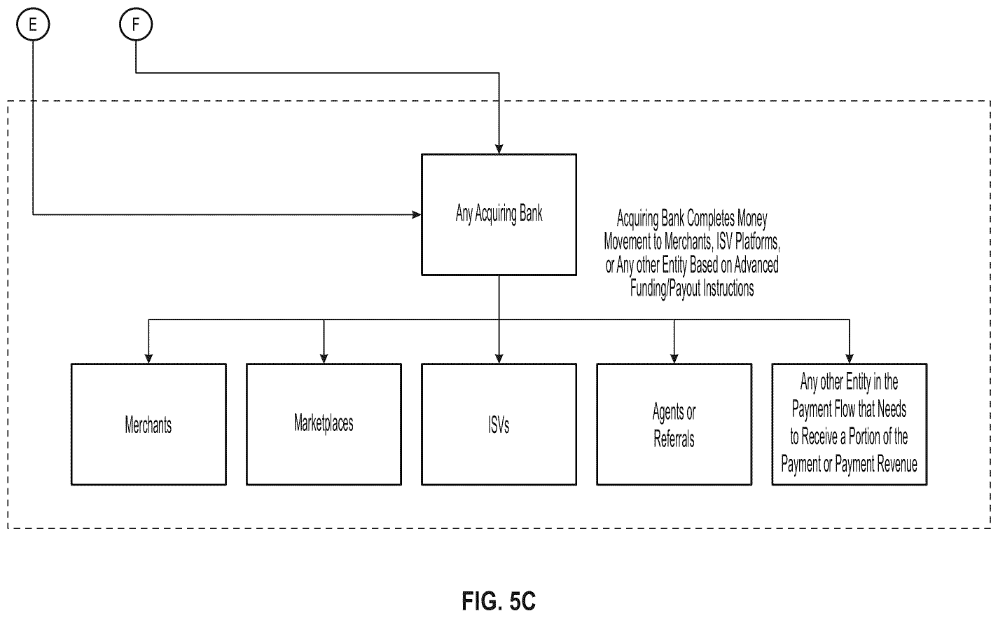

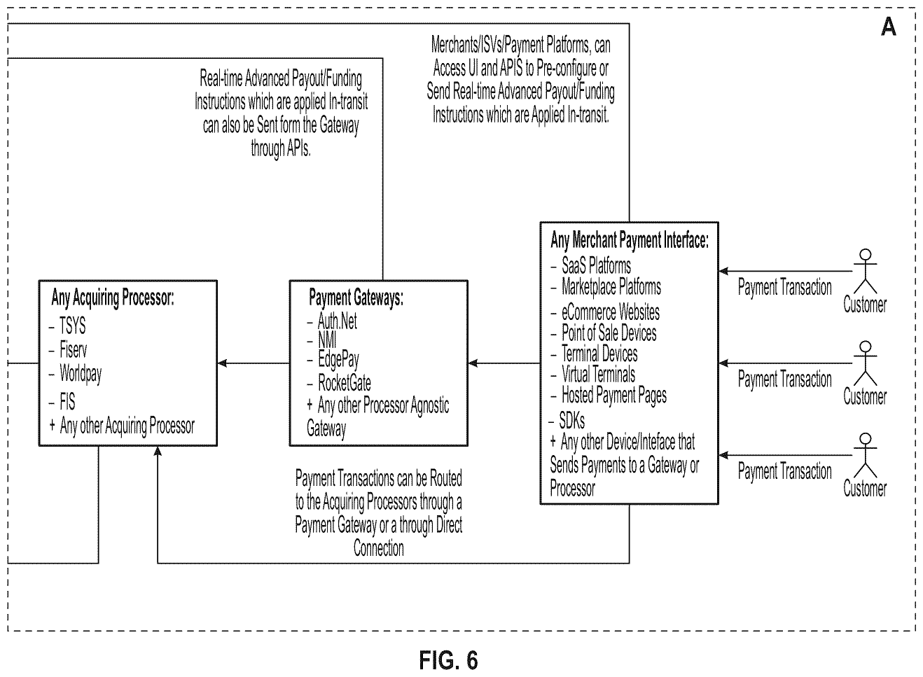

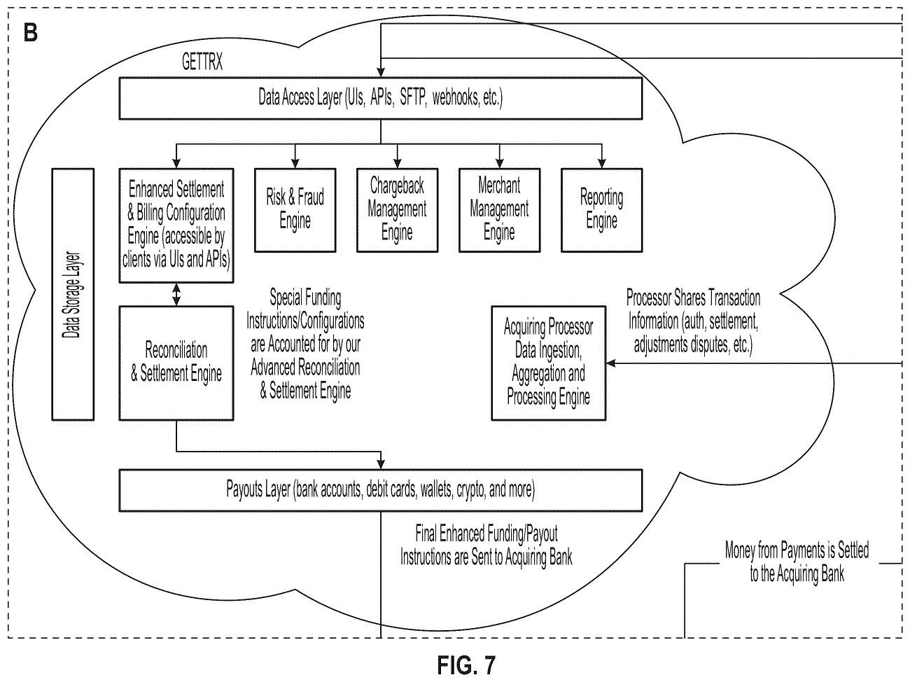

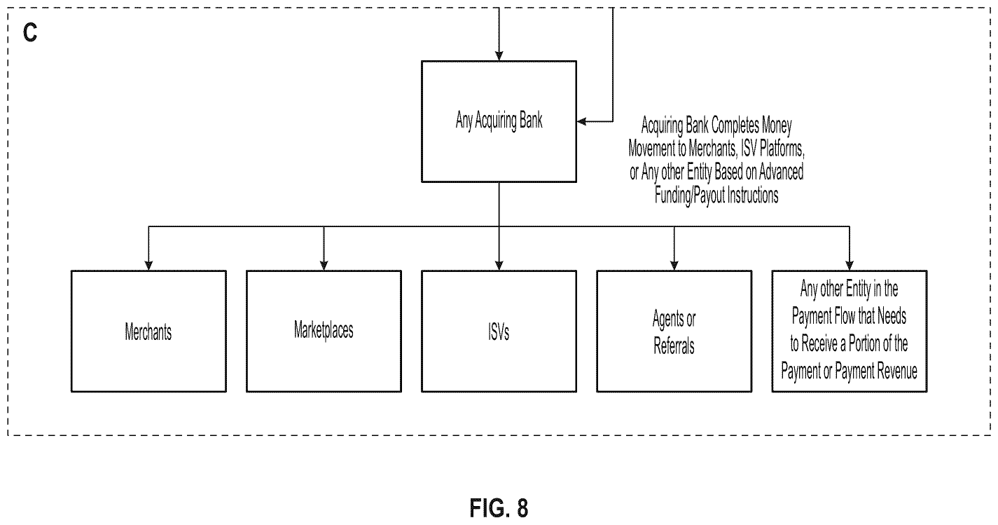

FIG. 5 shows various aspects of the advanced transactional platform resulting from system integration according to some embodiments. FIG. 6 depicts a zoomed view of FIG. 5 section A according to some embodiments. FIG. 7 shows a zoomed view of FIG. 5 section B according to some embodiments. FIG. 8 depicts a zoomed view of FIG. 5 section C according to some embodiments. In some embodiments, the system includes a funding flow management module. The funding flow management module provides the flexibility that conventional acquirer processors do not offer to traditional merchant accounts. In some embodiments, the funding flow management module is configured to split payments based on percentage or dollar amounts; generate custom fee structures (e.g., billed on a daily, weekly, or monthly basis); and/or support complex instructional funding at the transaction level.

As a non-limiting no-code example, the system is configured to enable a company to login to the system dashboard and configure how to split a payment to fund different amounts to multiple entities without changing their existing API integration to the gateway. In some embodiments, this is possible because aspects of the system include a transaction modifier engine configured to integrate behind the acquirer processor allowing the system to intercept the transaction within the transactional platform framework.

In some embodiments, the system includes a dynamic pricing module. In some embodiments, the dynamic pricing module is configured to enable companies to create different pricing programs tailored to their merchants' needs. In some embodiments, different pricing programs include subscription plans (e.g., free, pro and premium), volume tiers (discount rates decrease as volume exceeds a threshold), and/or at the transaction level through system APIs. In some embodiments, even newer acquirer processors do not give a customer this level of micro-customization.

As a non-limiting no code example, the system is configured to enable a company to log in to the dashboard and configure how each merchant's transaction will be priced. In some embodiments, they could set a regular pricing program (e.g., 2.9%+$0.30) for payments below $1,000 and another pricing program (e.g., Interchange Plus 0.50%) for payments above $1,000. In some embodiments, this pricing flexibility is currently not offered by any legacy acquirer processor or conventional payment platforms.

In some embodiments, the system includes an advanced residuals module (the terms “module” and “engine” may be used interchangeably herein). In some embodiments, the advanced residuals module is configured to offer options for receiving residuals that align with a company's preferences. In some embodiments, the system is configured to enable companies to choose daily, weekly, or monthly residual payments. In some embodiments, the system is configured to enable them to choose different deposit methods for faster residual delivery (e.g., like debit cards, wallets, crypto, etc.).

In some embodiments, at the transactional platform (legacy gateway) level, there is no need for the system to recognize all the different transactional platforms' formats that are supported because the system's transaction modifier engine (Global Electronic Technology, Inc.®) is integrated at the acquirer processor level. (See FIG. 2). In some embodiments, to add more acquirer processors, the transaction modifier engine is configured to recognize the format of each of them. (See FIG. 3).

In some embodiments, the system is configured to use gateway application program interfaces (APIs) to connect to independent software vendors (ISVs). In some embodiments, the system is configured to provide, without the use of gateway APIs, one or more of: real-time onboarding & optimization, flexible pricing, flexible fee structures, custom funding, split funding, push to debit cards, and advanced monetization. In some embodiments, the transaction modifier engine is configured to provide a plurality of transactional instructions into conventional merchant platforms with no-coding. In some embodiments, the integration does not require code development, and can be initiated with a click of a button. In some embodiments, the transaction modifier engine is configured to integrate advanced payment capabilities into an existing payment provider (e.g., Authorize.Net®, Network Merchants, LLC®, Total System Services LLC®, or any gateway that supports Total System Services LLC® systems or other desired systems).

In some embodiments, the majority of a merchant platform's revenue comes from an integrated payment service. In some embodiments, conventional merchant platforms that host merchant online stores currently collect 51% of revenue from the fees, charges, or percentages associated with processing payments made by customers to the merchants. In some embodiments, the fully integrated platform model is so successful that vertical payment platforms are now powering virtually every corner of the economy. In some embodiments, payment platforms participate financially in all of the economic activity that they enable. In some embodiments, hair salons, coffee shops, ecommerce platforms, bookkeepers, etc., all rely on hard-coded payment platforms to process payments.

In some embodiments, the system is configured to combine subscription revenue with payments monetization.

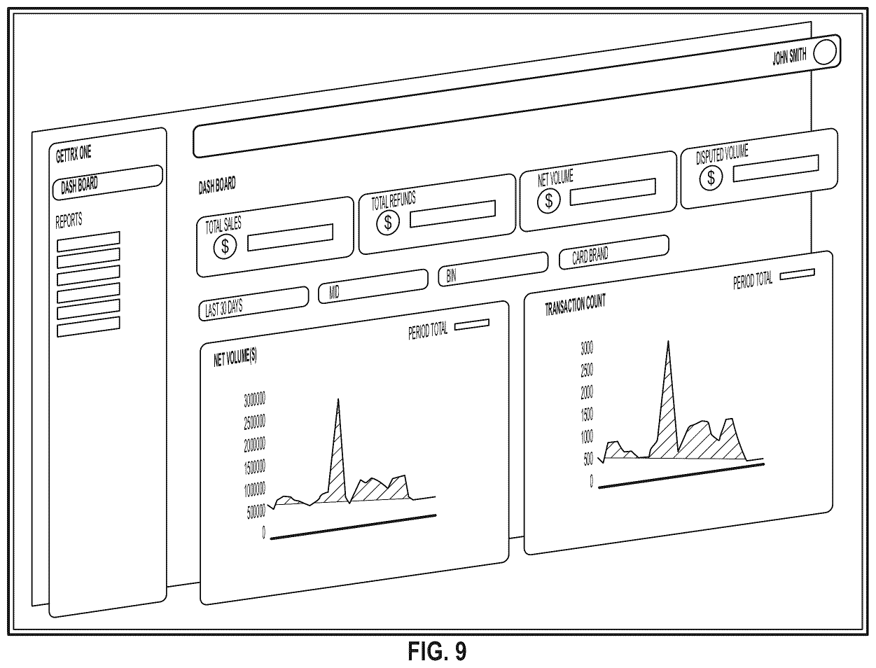

FIGS. 9-15 depict various acronyms which are defined as follows: MD: Merchant ID, a unique identifier for a merchant in a payment processing system. BIN: Bank Identification Number, the initial sequence of four to six numbers that appears on a credit card, which identifies the institution that issued the card. DBA: Doing Business As, the trading name under which a business or operation is conducted. SD: Sub-Merchant ID, an identifier for a sub-entity or a division within a larger merchant organization.

FIG. 9 shows a non-limiting example system dashboard according to some embodiments. In some embodiments, the dashboard includes a comprehensive view of a merchant's financial activity, with sections including, but not limited to, total sales, total refunds, net volume, and disputed volume over the last 30 days. In some embodiments, the dashboard includes a graphical representation of net volumes and transaction counts which allows for quick visual assessment of sales trends. In some embodiments, the dashboard also acts as central hub for accessing all other modules and/or features.

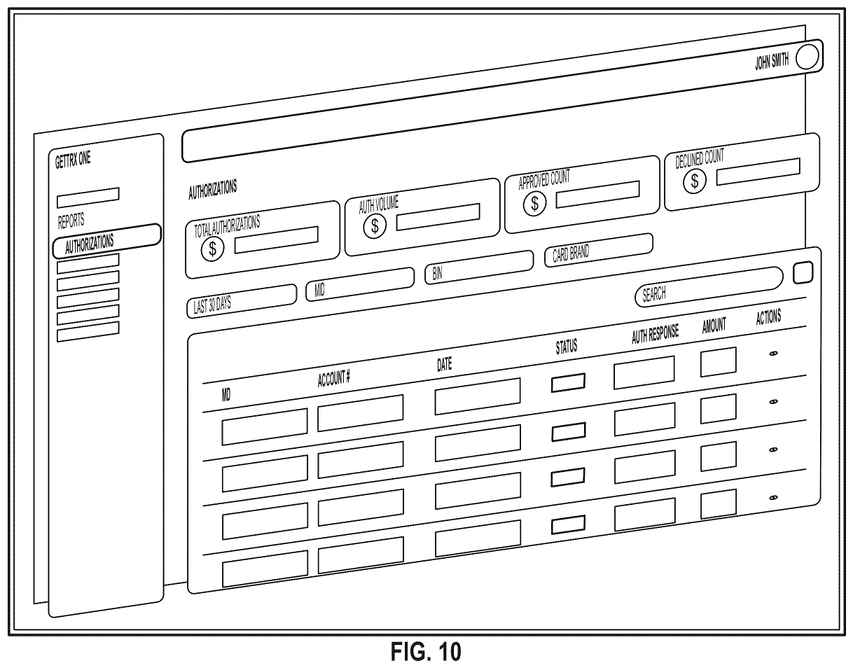

FIG. 10 depicts an authorizations GUI according to some embodiments. In some embodiments, the authorizations GUI displays authorization-related data such as, but not limited to, total dollar amounts authorized, volumes, approved and declined counts, providing insights into transaction approvals over the last 30 days.

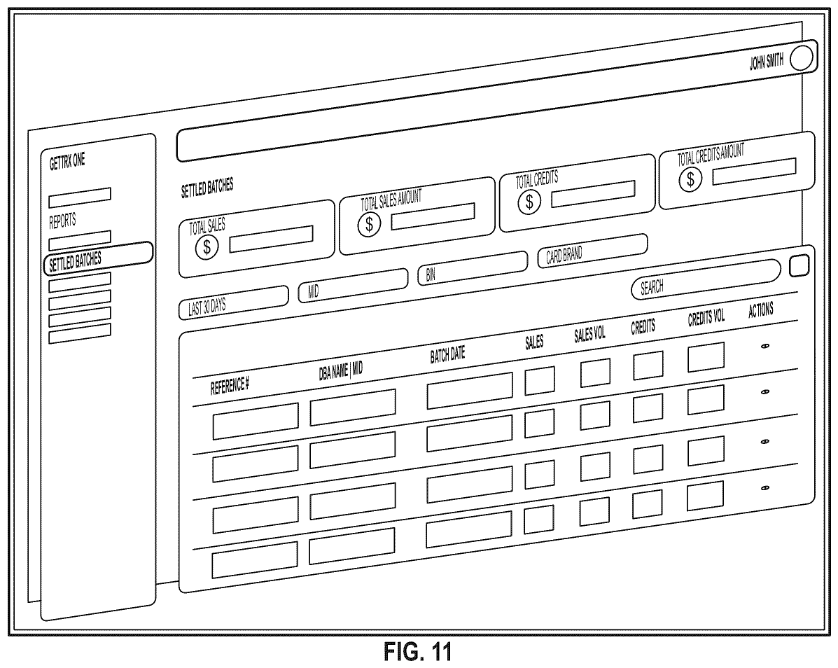

FIG. 11 illustrates a settled batches GUI according to some embodiments. In some embodiments, the Settled Batches interface includes data on completed transactions, including total sales and credits, both in terms of counts and dollar amounts. In some embodiments, merchants can view settlement details over the past 30 days, filter by MD, BIN, and card brand, and manage individual batches through one or more tables comprising reference numbers, batch dates, volumes, and actions.

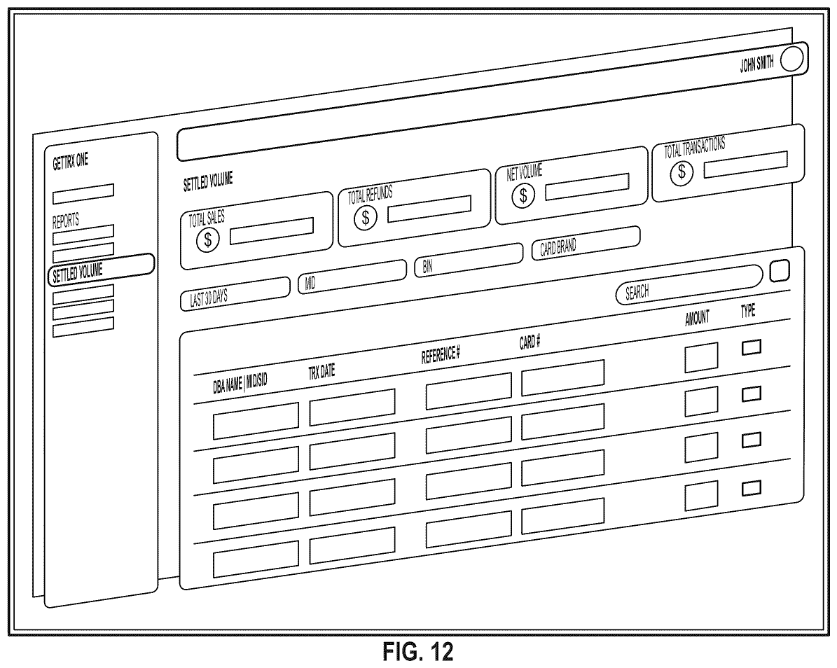

FIG. 12 shows a settled volume GUI according to some embodiments. In some embodiments, the settled volume GUI includes a view of the total sales, refunds, net volume, and total transactions over the last 30 days. In some embodiments, the associated table enables merchants to examine individual transactions, including DBA name, merchant/sub-merchant ID, date, reference number, card number, amount, and type, facilitating a granular analysis of sales data.

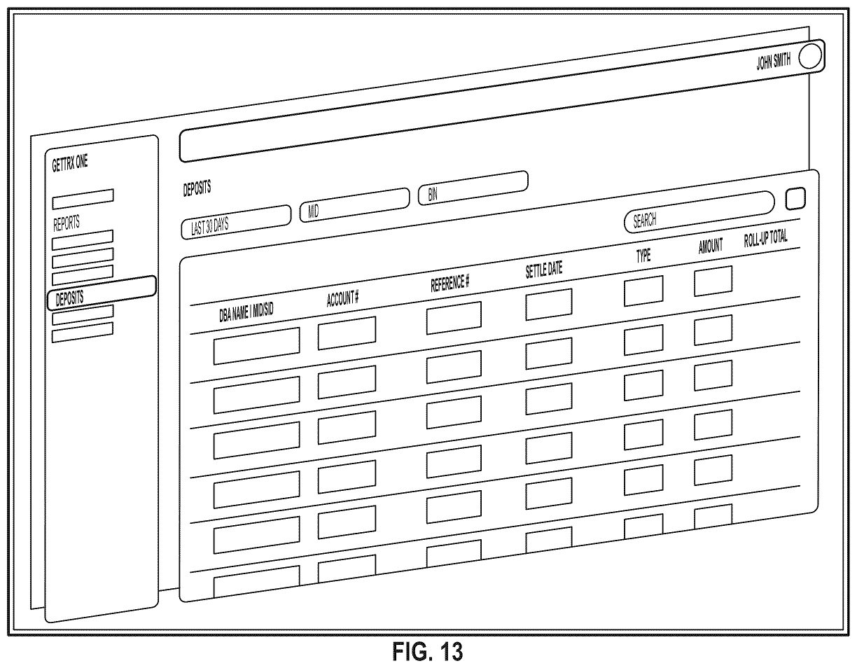

FIG. 13 shows a deposits GUI according to some embodiments. In some embodiments, the deposits GUI includes, without limitation, funds transferred to the merchant's account, data for the last 30 days and is filterable by MD and BIN. In some embodiments, the deposits GUI includes a table that lists deposit transactions with details like DBA name, merchant/sub-merchant ID, account number, reference number, settlement date, type, amount, and a roll-up total, enhancing cash flow visibility.

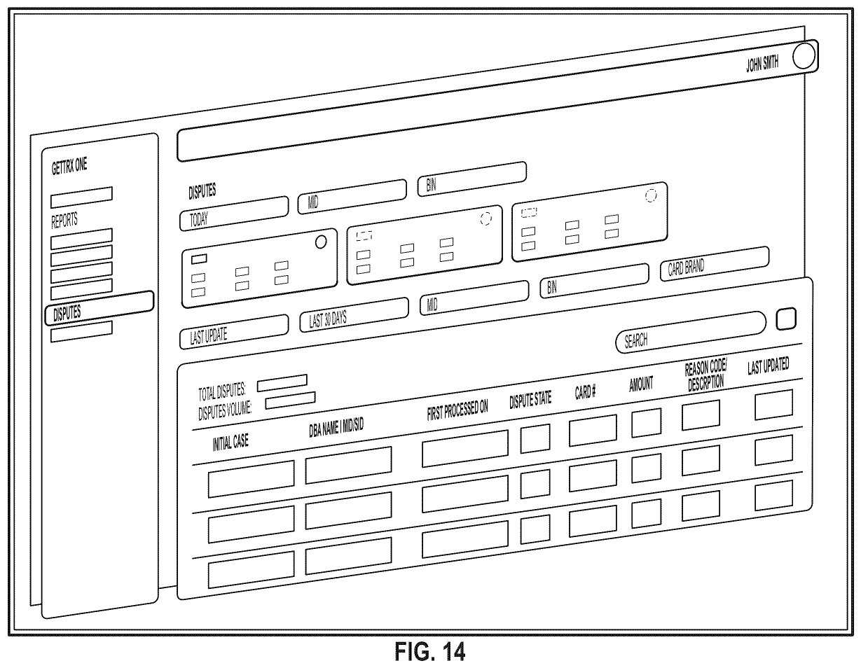

FIG. 14 illustrates a disputes GUI according to some embodiments. In some embodiments, the disputes GUI is configured to manage chargebacks and disputes, showing data for the current day and the last 30 days, sortable by MD, BIN, and card brand.

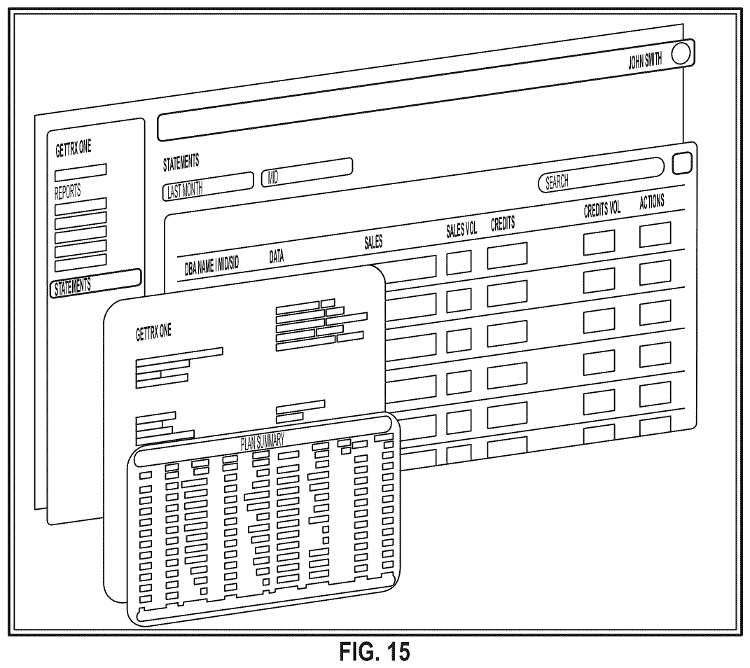

FIG. 15 shows a statements GUI. In some embodiments, the statements GUI provides a historical financial summary for the last month, with filters for MD to facilitate data retrieval, as non-limiting examples. In some embodiments, the statements GUI includes a table that lists, as non-limiting examples, financial statements by DBA name, merchant/sub-merchant ID, date, and also provides details on sales, sales volume, credits, and actions available for managing statements.

In some embodiments, the system is configured to use artificial intelligence (AI) to perform analytics on data and/or determine what information is displayed in a graphical user interface. In some embodiments, for the dashboard GUI, the AI is configured to analyze historical transaction data to predict future sales trends, which can be visualized in net volume and transaction count graphs. In some embodiments, the AI is configured to identify patterns in refunds and disputes, providing recommendations to reduce such occurrences. In some embodiments, the system includes AI-driven segmentation configured to automatically categorize transactions by BIN and Card Brand for more targeted analysis.

In some embodiments, the authorizations GUI uses AI to predict authorization approval rates based on past transaction data, helping merchants optimize their payment acceptance strategies. In some embodiments, the AI is configured to detect and flag potentially fraudulent transactions by analyzing authorization response patterns. In some embodiments, the AI is configured to detect and flag potentially fraudulent transactions by analyzing authorization response patterns. In some embodiments, the AI is configured to suggest actionable steps to improve authorization rates, which can be presented in an ‘actions’ column of a table.

In some embodiments, the settled batches GUI uses AI to analyze batch settlement data to identify anomalies or inefficiencies in the settlement process. In some embodiments, the AI is configured to forecast cash flow based on settled batch trends, aiding in financial planning. In some embodiments, the AI is configured to prioritize which batches require manual review or intervention, streamlining operations.

In some embodiments, the settled batches GUI is configured to use AI to use transaction data to create predictive models for future sales volumes and refund rates. In some embodiments, the AI provides insights into customer spending behavior, helping merchants tailor their offerings. In some embodiments, the AI is configured to recommend adjustments to transaction types based on performance metrics.

In some embodiments, portions of the deposits GUI are generated by the AI analyzing deposit patterns to predict future deposit amounts and timings, improving liquidity management. In some embodiments, the AI is configured to identify irregularities in deposit activities that may indicate errors or fraud. In some embodiments, AI is configured to optimize the roll-up totals by analyzing the most relevant data points for the merchant's financial needs.

In some embodiments, for the disputes GUI, the AI is configured to predict dispute likelihood based on transaction characteristics and historical dispute data. In some embodiments, the AI is configured to automate the categorization of disputes by reason code and description, aiding in quicker resolution. In some embodiments, the AI is configured to recommend preventive measures to reduce future disputes based on learned patterns.

In some embodiments, the statements GUI includes AI analysis of statement data to display a summary of financial health, highlighting key areas of interest. In some embodiments, the AI is configured to detect trends in sales and credits, offering insights for improving financial performance. In some embodiments, the AI is configured to automate the generation of financial reports, reducing manual effort and errors.

In each GUI, AI analytics can be used to personalize the dashboard experience for each merchant by learning from their specific transaction patterns and preferences according to some embodiments. In some embodiments, this includes custom alerts, anomaly detection, and recommendations for actions that can improve the merchant's financial operations.

Various AI models are used to populate portions of the GUIs and/or to provide the functionality described herein according to some embodiments. In some embodiments, for predictive analytics, Machine Learning (ML) models, including regression algorithms for forecasting and classification algorithms for categorization, can be used. In some embodiments, the ML models are trained on historical transaction data, including sales, refunds, authorizations, and disputes. In some embodiments, the training process includes feeding the model with features such as transaction amounts, times, frequencies, and outcomes, and then adjusting the model parameters to minimize prediction errors.

In some embodiments, suitable AI driven anomaly detection includes unsupervised learning algorithms, such as clustering or neural network-based autoencoders. In some embodiments, the unsupervised learning algorithms are trained to understand the normal patterns of transactional data. In some embodiments, the unsupervised learning algorithms identify outliers or anomalies that deviate significantly from established patterns, signaling potential fraud or errors without explicit labels for what constitutes an anomaly.

In some embodiments, Natural Language Processing (NLP) techniques are used for understanding and categorizing reason codes and descriptions in disputes. In some embodiments,

NLP models are trained on text data from dispute descriptions, using techniques such as sentiment analysis and topic modeling to extract meaningful patterns and categorize disputes automatically.

In some embodiments, decision support systems use rule-based systems or reinforcement learning for recommending actions. In some embodiments, rule-based or reinforcement learning systems are trained using a combination of historical data and expert input to establish rules or policies that guide decision-making. In some embodiments, reinforcement learning systems are configured to improve over time by learning which actions lead to the best outcomes.

In some embodiments, the system uses deep learning, including convolutional neural networks (CNNs) for visual pattern recognition in graphs and charts. In some embodiments, the CNNs are trained on graphical representations of data to detect and interpret patterns, trends, and correlations. In some embodiments, the CNNs are provided a dataset of labeled images or sequences where the patterns are identified and associated with specific financial outcomes.

In some embodiments, the system employs ML models for time series forecasting, which may include, as non-limiting examples, ARIMA (AutoRegressive Integrated Moving Average) or LSTM (Long Short-Term Memory) networks. In some embodiments, the ML models are trained on sequential data to predict future data points in a series. In some embodiments, training data includes historical time-stamped data, with the models learning to forecast future values based on past trends and cycles.

For training these AI systems, a robust dataset is typically be sourced from transactional records, and is preprocessed to handle missing values, outliers, and to ensure it is in a format suitable for the AI models. In some embodiments, the models undergo a training phase where they learn from the data, followed by a validation phase to tune hyperparameters and prevent overfitting. Finally, the models are tested on unseen data to evaluate their performance before being deployed into the production environment.

It is understood that functionality (including AI functionality) and/or visualizations of one GUI or module can be readily incorporated into another GUI or module, as the functionality explained according to these non-limiting examples are of the system as a whole.

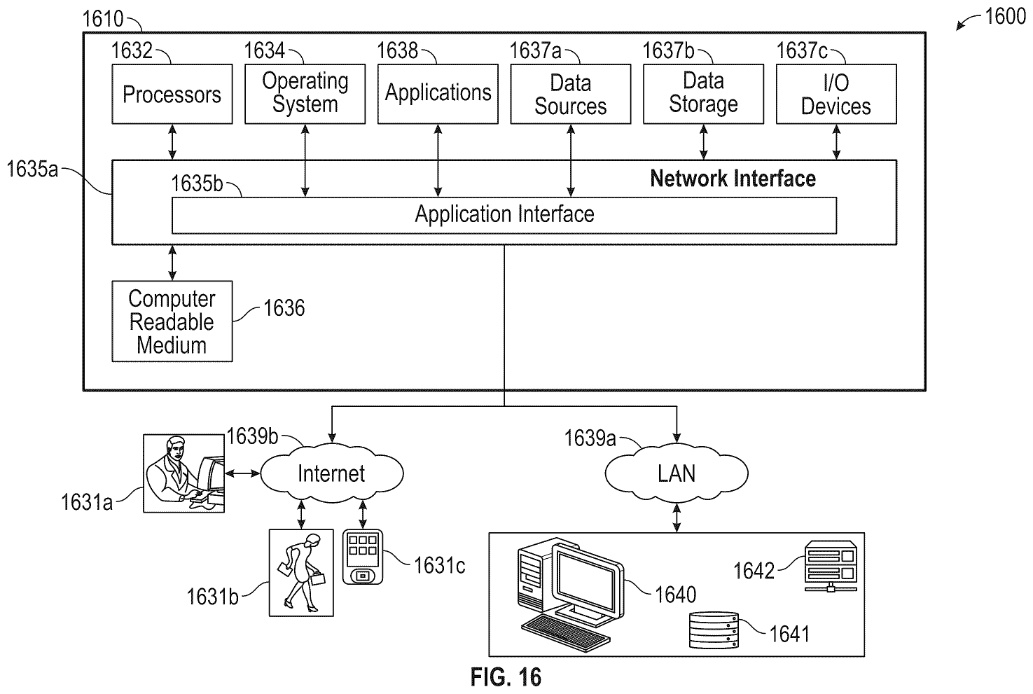

FIG. 16 illustrates a computer system 1610 enabling or comprising the systems and methods in accordance with some embodiments. In some embodiments, the computer system 1610 is configured to operate and/or process computer-executable code of one or more software modules of the aforementioned system and method. Further, in some embodiments, the computer system 1610 is configured to operate and/or display information within one or more graphical user interfaces (e.g., HMIs) integrated with or coupled to the system.

In some embodiments, the computer system 1610 comprises one or more processors 1632. In some embodiments, at least one processor 1632 resides in, or is coupled to, one or more servers. In some embodiments, the computer system 1610 includes a network interface 1635a and an application interface 1635b coupled to the least one processor 1632 capable of processing at least one operating system 1634. Further, in some embodiments, the interfaces 1635a, 1635b coupled to at least one processor 1632 are configured to process one or more of the software modules (e.g., such as enterprise applications 1638). In some embodiments, the software application modules 1638 includes server-based software. In some embodiments, the software application modules 1638 are configured to host at least one user account and/or at least one client account, and/or are configured to operate to transfer data between one or more of these accounts using one or more processors 1632.

With the above embodiments in mind, it is understood that the system is configured to execute various computer-implemented program steps involving data stored on one or more non-transitory computer media according to some embodiments. In some embodiments, the above-described databases and models described throughout this disclosure are configured to store analytical models and other data on non-transitory computer-readable storage media within the computer system 1610 and on computer-readable storage media coupled to the computer system 1610 according to some embodiments. In addition, in some embodiments, the above-described applications of the system are stored on computer-readable storage media within the computer system 1610 and on computer-readable storage media coupled to the computer system 1610. In some embodiments, these operations are those requiring physical manipulation of structures including electrons, electrical charges, transistors, amplifiers, receivers, transmitters, and/or any conventional computer hardware in order to transform an electrical input into a different output. In some embodiments, these structures include one or more of electrical, electromagnetic, magnetic, optical, and/or magneto-optical signals capable of being stored, transferred, combined, compared and otherwise manipulated. In some embodiments, the computer system 1610 comprises at least one computer readable medium 1636 coupled to at least one of at least one data source 1637a, at least one data storage 1637b, and/or at least one input/output 1637c. In some embodiments, the computer system 1610 is embodied as computer readable code on a computer readable medium 1636. In some embodiments, the computer readable medium 1636 includes any data storage that stores data, which is configured to thereafter be read by a computer (such as computer 1640). In some embodiments, the non-transitory computer readable medium 1636 includes any physical or material medium that is used to tangibly store the desired information, steps, and/or instructions and which is configured to be accessed by a computer 1640 or processor 1632. In some embodiments, the non-transitory computer readable medium 1636 includes hard drives, network attached storage (NAS), read-only memory, random-access memory, FLASH-based memory, CD-ROMs, CD-Rs, CD-RWs, DVDs, magnetic tapes, and/or other optical and non-optical data storage. In some embodiments, various other forms of computer-readable media 1636 are configured to transmit or carry instructions to one or more remote computers 1640 and/or at least one user 1631, including a router, private or public network, or other transmission or channel, both wired and wireless. In some embodiments, the software application modules 1638 are configured to send and receive data from a database (e.g., from a computer readable medium 1636 including data sources 1637a and data storage 1637b that comprises a database), and data is configured to be received by the software application modules 1638 from at least one other source. In some embodiments, at least one of the software application modules 1638 are configured to be implemented by the computer system 1610 to output data to at least one user 1631 via at least one graphical user interface rendered on at least one digital display.

In some embodiments, the one or more non-transitory computer readable media 1636 are distributed over a conventional computer network via the network interface 1635a where some embodiments stored the non-transitory computer readable media are stored and executed in a distributed fashion. For example, in some embodiments, one or more components of the computer system 1610 are configured to send and/or receive data through a local area network (“LAN”) 1639a and/or an internet coupled network 1639b (e.g., such as a wireless internet). In some embodiments, the networks 1639a, 1639b include one or more wide area networks (“WAN”), direct connections (e.g., through a universal serial bus port), or other forms of computer-readable media 1636, and/or any combination thereof.

In some embodiments, components of the networks 1639a, 1639b include any number of personal computers 1640 which include for example desktop computers, laptop computers, and/or any fixed, generally non-mobile internet appliances coupled through the LAN 1639a. For example, some embodiments include one or more personal computers 1640, databases 1641, and/or servers 1642 coupled through the LAN 1639a that are configured for use by any type of user including an administrator. Some embodiments include one or more personal computers 1640 coupled through network 1639b. In some embodiments, one or more components of the computer system 1610 are configured to send or receive data through an internet network (e.g., such as network 1639b). For example, some embodiments include at least one user 1631a, 1631b, coupled wirelessly and accessing one or more software modules of the system including at least one enterprise application 1638 via an input and output (“I/O”) 1637c. In some embodiments, the computer system 1610 is configured to enable at least one user 1631a, 1631b, to be coupled to access enterprise applications 1638 via an I/O 1637c through LAN 1639a. In some embodiments, the user 1631 includes a user 1631a coupled to the computer system 1610 using a desktop computer, and/or laptop computers, or any fixed, generally non-mobile internet appliances coupled through the internet 1639b. In some embodiments, the user includes a mobile user 1631b coupled to the computer system 1610. In some embodiments, the user 1631b connects using any mobile computing 1631c to wireless coupled to the computer system 1610, including, but not limited to, one or more personal digital assistants, at least one cellular phone, at least one mobile phone, at least one smart phone, at least one pager, at least one digital tablet, and/or at least one fixed or mobile internet appliances.

The disclosure describes the specifics of how a machine, including one or more computers comprising one or more processors and one or more non-transitory computer readable media, implement the system and its improvements over the prior art. The instructions executed by the machine cannot be performed in the human mind or derived by a human using a pen and paper but require the machine to convert process input data to useful output data. Moreover, the claims presented herein do not attempt to tic-up a judicial exception with known conventional steps implemented by a general-purpose computer; nor do they attempt to tic-up a judicial exception by simply linking it to a technological field. Indeed, the systems and methods described herein were unknown and/or not present in the public domain at the time of filing, and they provide technologic improvements and/or advantages not known in the prior art. Furthermore, the system includes unconventional steps that confine the claim to a useful application.

It is understood that the system is not limited in its application to the details of construction and the arrangement of components set forth in the previous description or illustrated in the drawings. The system and methods disclosed herein fall within the scope of numerous embodiments. The previous discussion is presented to enable a person skilled in the art to make and use embodiments of the system. Any portion of the structures and/or principles included in some embodiments can be applied to any and/or all embodiments: it is understood that features from some embodiments presented herein are combinable with other features according to some other embodiments. Thus, some embodiments of the system are not intended to be limited to what is illustrated but are to be accorded the widest scope consistent with all principles and features disclosed herein.

Some embodiments of the system are presented with specific values and/or setpoints. These values and setpoints are not intended to be limiting and are merely examples of a higher configuration versus a lower configuration and are intended as an aid for those of ordinary skill to make and use the system.

Any text in the drawings are part of the system's disclosure and is understood to be readily incorporable into any description of the metes and bounds of the system. Any functional language in the drawings is a reference to the system being configured to perform the recited function, and structures shown or described in the drawings are to be considered as the system comprising the structures recited therein. Any figure depicting a content for display on a graphical user interface is a disclosure of the system configured to generate the graphical user interface and configured to display the contents of the graphical user interface. It is understood that defining the metes and bounds of the system using a description of images in the drawing does not need a corresponding text description in the written specification to fall with the scope of the disclosure.

Furthermore, acting as Applicant's own lexicographer, Applicant imparts the explicit meaning and/or disavow of claim scope to the following terms:

Applicant defines any use of “and/or” such as, for example, “A and/or B,” or “at least one of A and/or B” to mean element A alone, element B alone, or elements A and B together. In addition, a recitation of “at least one of A, B, and C,” a recitation of “at least one of A, B, or C,” or a recitation of “at least one of A, B, or C or any combination thereof” are each defined to mean element A alone, element B alone, element C alone, or any combination of elements A, B and C, such as AB, AC, BC, or ABC, for example.

“Substantially” and “approximately” when used in conjunction with a value encompass a difference of 5% or less of the same unit and/or scale of that being measured.

“Simultaneously” as used herein includes lag and/or latency times associated with a conventional and/or proprietary computer, such as processors and/or networks described herein attempting to process multiple types of data at the same time. “Simultaneously” also includes the time it takes for digital signals to transfer from one physical location to another, be it over a wireless and/or wired network, and/or within processor circuitry.

As used herein, “can” or “may” or derivations there of (e.g., the system display can show X) are used for descriptive purposes only and is understood to be synonymous and/or interchangeable with “configured to” (e.g., the computer is configured to execute instructions X) when defining the metes and bounds of the system. The phrase “configured to” also denotes the step of configuring a structure or computer to execute a function in some embodiments.

In addition, the term “configured to” means that the limitations recited in the specification and/or the claims must be arranged in such a way to perform the recited function: “configured to” excludes structures in the art that are “capable of” being modified to perform the recited function but the disclosures associated with the art have no explicit teachings to do so. For example, a recitation of a “container configured to receive a fluid from structure X at an upper portion and deliver fluid from a lower portion to structure Y” is limited to systems where structure X, structure Y, and the container are all disclosed as arranged to perform the recited function. The recitation “configured to” excludes elements that may be “capable of” performing the recited function simply by virtue of their construction but associated disclosures (or lack thereof) provide no teachings to make such a modification to meet the functional limitations between all structures recited. Another example is “a computer system configured to or programmed to execute a series of instructions X, Y, and Z.” In this example, the instructions must be present on a non-transitory computer readable medium such that the computer system is “configured to” and/or “programmed to” execute the recited instructions: “configure to” and/or “programmed to” excludes art teaching computer systems with non-transitory computer readable media merely “capable of” having the recited instructions stored thereon but have no teachings of the instructions X, Y, and Z programmed and stored thereon. The recitation “configured to” can also be interpreted as synonymous with operatively connected when used in conjunction with physical structures.

It is understood that the phraseology and terminology used herein is for description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The previous detailed description is to be read with reference to the figures, in which like elements in different figures have like reference numerals. The figures, which are not necessarily to scale, depict some embodiments and are not intended to limit the scope of embodiments of the system.

Any of the operations described herein that form part of the invention are useful machine operations. The invention also relates to a device or an apparatus for performing these operations. All flowcharts presented herein represent computer implemented steps and/or are visual representations of algorithms implemented by the system. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general-purpose computer selectively activated or configured by one or more computer programs stored in the computer memory, cache, or obtained over a network. When data is obtained over a network the data can be processed by other computers on the network, e.g., a cloud of computing resources.

The embodiments of the invention can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, some embodiments include methods which can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Although method operations are presented in a specific order according to some embodiments, the execution of those steps do not necessarily occur in the order listed unless explicitly specified. Also, other housekeeping operations can be performed in between operations, operations can be adjusted so that they occur at slightly different times, and/or operations can be distributed in a system which allows the occurrence of the processing operations at various intervals associated with the processing, as long as the processing of the overlay operations are performed in the desired way and result in the desired system output.

It will be appreciated by those skilled in the art that while the system has been described above in connection with particular embodiments and examples, the system is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

We claim:

1. A system for processing electronic payments comprising:
one or more computers comprising one or more central processing units (CPUs) and one or more non-transitory computer readable media, the one or more non-transitory computer readable media comprising program instructions stored thereon that when executed cause the one or more computers to:
execute, by the one or more CPUs, a transaction modifier engine configured to modify transactional data;
receive, by the one or more CPUs, first transactional data from one or more acquirer processors;
compare, by the one or more CPUs, the first transactional data to transactional information stored by the transaction modifier engine;
modify, by the one or more CPUs, the first transactional data into second transactional data using the transactional information; and
send, by the one or more CPUs, the second transactional data to one or more acquiring banks.

2. The system of claim 1,
wherein the one or more non-transitory computer readable media further comprise program instructions stored thereon that when executed cause the one or more computers to:
integrate, by the one or more CPUs, the transaction modifier engine with a transactional platform;
wherein the transactional platform comprise a link to one or more payment gateways;
wherein the one or more payment gateways are configured to receive the transactional data from a merchant;
wherein the one or more payment gateways are configured to send the transactional data to the one or more acquirer processors as the first transactional data; and
wherein the one or more acquirer processors are configured to send the first transactional data to the one or more acquiring banks.

3. The system of claim 2,
wherein the integration includes the transaction modifier engine intercepting the first transactional data sent from the one or more acquirer processors to the one or more acquiring banks.

4. The system of claim 2,
wherein the transactional platform comprises hard coding configured to instruct the one or more acquirer processors to send the first transactional data directly to the one or more acquiring banks.

5. The system of claim 4,
wherein the integration does not require changing the hard coding of the transactional platform.

6. The system of claim 5,
wherein executing the transaction modifier engine includes executing instructions configured to prevent a transmission of the first transactional data from the one or more acquirer processors to the one or more acquiring banks.

7. The system of claim 2,
wherein the one or more non-transitory computer readable media further comprise program instructions stored thereon that when executed cause the one or more computers to:
prevent, by the one or more CPUs, a transmission of the first transactional data from the one or more acquirer processors to the one or more acquiring banks.

8. The system of claim 7,
wherein the second transactional data includes funding instructions not included in the first transactional data.

9. The system of claim 8,
wherein the funding instructions include instructions to divide a payment to the merchant among a plurality of accounts.

10. The system of claim 7,
wherein the transaction modifier engine includes a dynamic pricing module configured to enable the merchant to create different pricing programs.

11. The system of claim 10,
wherein the different pricing programs include subscription programs.

12. The system of claim 10,
wherein the different pricing programs include how a merchant's transactions will be priced.

13. The system of claim 10,
wherein the different pricing programs include different deposit methods.

14. The system of claim 2,
wherein the one or more non-transitory computer readable media further comprise program instructions stored thereon that when executed cause the one or more computers to:
store, by the one or more CPUs, a plurality of transactional data associated with the merchant; and
execute, by the one or more CPUs, an analysis of the plurality of transaction data.

15. The system of claim 14,
wherein the one or more non-transitory computer readable media further comprise program instructions stored thereon that when executed cause the one or more computers to:
generate, by the one or more CPUs, a graphical user interface (GUI) configured to enable a user to access the transaction modifier engine.

16. The system of claim 15,
wherein the graphical user interface is configured to enable the user to implement one or more of: subscription plans, deposit methods, settlement instructions, merchant transactional prices, and residuals.

17. The system of claim 15,
wherein the graphical user interface is configured to display reports based on the plurality of transactional data;
wherein the reports comprise one or more of: authorizations, settled batches, settled volume, deposits, disputes, and statements.

18. The system of claim 17,
wherein the reports are generated using artificial intelligence (AI).
